(19) United States
(12) Patent Application Publication
(10) Pub. No.: US 2007/0170364 A1
(43) Pub. Date: Jul. 26, 2007

(54) Alpha ray dose rate measuring method

(75) Inventors: Ryozo Takasu, Kawasaki (JP); Hiroyuki Fukuda, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/723,612

(22) Filed: Mar. 21, 2007

Related U.S. Application Data
(63) Continuation of application No. PCT/JP04/14183, filed on Sep. 28, 2004.

(51) Int. Cl. G01T 1/178; G01T 1/24

(52) U.S. Cl. 250/370.02

(57) ABSTRACT

The α ray dose rate measuring method according to the present invention comprises the first step of leaving a solid state track detector 12 and a sample 10 superimposed on each other for a prescribed period of time; the second step of etching the solid state track detector to thereby form in the solid state track detector etch pits 20 corresponding to tracks of α rays incident on the solid state track detector; and the third step of giving a dose rate of α rays emitted from the sample, based on a number of the etch pits formed in the solid state track detector and a leaving period of time. The sample and the solid state track detector are left for a relatively long period of time, and a number of the etch pits is divided by the leaving period time to thereby give a dose rate of α rays, whereby as the leaving period of time is set longer, the background can be made less influential. Thus, the dose rate of α rays can be given with very high precision.

### CROSS REFERENCE TO RELATED APPLICATION

This application is a Continuation of PCT application No. PCT/JP2004/014183, which was filed on Sep. 28, 2004, and which designated the United States of America.

### TECHNICAL FIELD

The present invention relates to an α ray dose rate measuring method, more specifically an α ray dose rate measuring method which can measure with high precision a dose rate of α ray emitted from a sample.

### BACKGROUND ART

Solder material, wiring material, sealing material, etc. contain traces of radioactive substances, and from these materials, often α rays are emitted. The α rays emitted from these materials affect the operation of semiconductor devices, the so-called soft errors have often took place. Recently, in order to provide semiconductor devices of higher reliability, countermeasures for the soft errors are very important.

To provide a semiconductor device which does not make easily soft errors, it is very important to use materials whose doses of α rays emitted therefrom are very small. To select materials whose doses of α rays emitted therefrom, it is necessary to accurately measure the doses of the α rays emitted from the materials.

As a device for measuring the dose of α rays emitted from a sample, conventionally gas-flow type proportional counter is known. The gas-flow type proportional counter can measure with an about 0.001 cph/cm² lower detection limit. The cph/cm² is an abbreviation of counter per hour/cm² and is a unit for the dose rate per a unit area. The dose rate is a quantity of radioactive rays per a unit time. The unit of cph/cm² is used to indicate how many a particles are emitted in 1 hour in a 1 cm² sample surface.

The techniques for measuring dose of α rays are proposed in Patent Reference 1 and Patent Reference 2.

Patent Reference 1: Specification of Japanese Patent Application Unexamined Publication No. 2003-50279

Patent Reference 2: Specification of Japanese Patent Application Unexamined Publication No. Hei 9-15336

### DISCLOSURE OF THE INVENTION

### Problems to be Solved by the Invention

However, the lower detection limit of the gas-flow type proportional counter is about 0.001 cph/cm² as described above, and the lower detection limit is not low enough. To provide a semiconductor device which makes less easily the soft errors, the semiconductor device is required to use materials whose dose rates of α rays emitted therefrom are sufficiently smaller than 0.001 cph/cm². To this end, a technique for measuring the dose of α rays with a lower detection limit which is lower has been expected.

An object of the present invention is to provide an α ray dose rate measuring method which can measure with high precision the dose rate of the α rays emitted from a sample with a lower detection limit which is very low.

### MEANS FOR SOLVING THE PROBLEMS

According to one aspect of the present invention, there is provided an α ray dose rate measuring method comprising: the first step of leaving a solid state track detector and a sample superimposed on each other for a prescribed period of time; the second step of etching the solid state track detector to thereby forming in the solid state track detector etch pits corresponding to tracks of α rays incident on the solid state track detector; and the third step of giving a dose rate of α rays emitted from the sample, based on a number of the etch pits formed in the solid state track detector and the leaving period of time.

### EFFECT OF THE INVENTION

According to the present invention, a sample and a solid state track detector are left for a relatively long period of time, and a number of etch pits is divided by the leaving period of time to give a dose rate of α rays, whereby as the leaving period of time is set longer, the background can be made less influential. Thus, according to the present invention, the dose rate of α rays can be given with very high precision.

According to the present invention, a sample and a solid state track detector are left, superimposed on each other, which permits α rays emitted from the sample to be incident on the solid state track detector without failure. Thus, according to the present invention, α rays emitted from the sample can be measured with high precision.

According to the present invention, a sample and an solid state track detector are left in a chamber having the inside evacuated, which can prevent the occurrence of tracks of α rays in the solid state track detector due to radioactive substances present in the air. Without the air between the sample and the solid state track detector, the arrival of α rays emitted from the sample at the solid state track detector is not hindered by the air. Thus, according to the prevent invention, the dose rate of α rays emitted from the sample can be accurately measured.

According to the present invention, a sample and an solid state track detector superimposed on each other are left, vacuum packed, which permits the dose rate of α rays can be accurately measured without operating a vacuum pump long.

According to the present invention, the periphery of the part where a sample and an solid state track detector are superimposed on each other is sealed with a sealant, whereby after sealed, the air containing radioactive substances never additionally intrudes between the sample and the solid state track detector. Thus, α rays emitted from the sample can be measured with high precision. Besides, according to the present invention, the sample does not have to be loaded in a vacuum pack container, which allows the dose rate of α rays emitted from a relatively large sample to be accurately measured.

### BRIEF DESCRIPTION OF THE DRAWINGS

FIGS. 1A and 1B are views illustrating the steps of the α ray dose rate measuring method according to a first embodiment of the present invention.

FIGS. 2A and 2B are views illustrating the steps of the α ray dose rate measuring method according to a second embodiment of the present invention.

FIGS. 3A to 3C are views illustrating the steps of the α ray dose rate measuring method according to a third embodiment of the present invention.

FIG. 4 is a view illustrating the step of the α ray dose rate measuring method according to a fourth embodiment of the present invention (Part 1).

FIGS. 5A and 5B are views illustrating the step of the α ray dose rate measuring method according to the fourth embodiment of the present invention (Part 2).

FIGS. 6A to 6C are views illustrating the steps of the α ray dose rate measuring method according to a fifth embodiment of the present invention.

FIGS. 7A to 7C are views illustrating the steps of the α ray dose rate measuring method according to a sixth embodiment of the present invention.

### REFERENCE NUMBER

10 . . . sample

12, 12a, 12b . . . solid state track detector

14 . . . chamber

16 . . . pipe

18 . . . vacuum pump

20 . . . etch pit

22, 22a . . . vacuum pack container

24 . . . sealant

### BEST MODE FOR CARRYING OUT THE INVENTION

### A First Embodiment

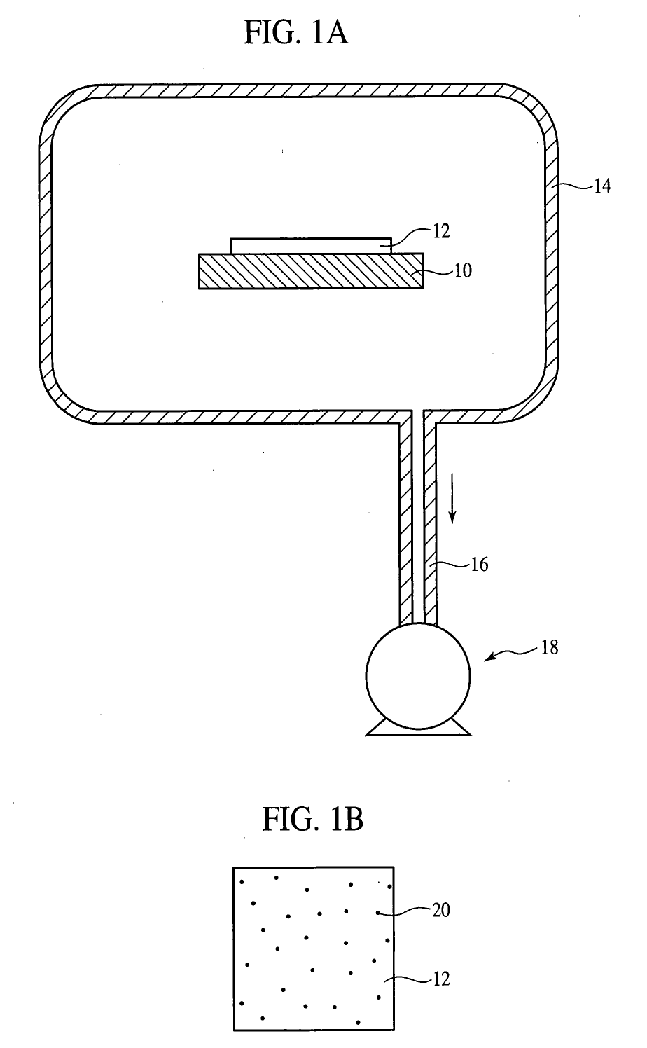

The α ray dose rate measuring method according to a first embodiment of the present invention will be explained with reference to FIGS. 1A and 1B. FIGS. 1A and 1B are views illustrating the steps of the α ray dose rate measuring method according to the present embodiment.

First, a sample 10 to be measured, and a solid state track detector (SSTD) 12 are prepared. The sample 10 is, e.g. a solder material, an electrode material, a wiring material, a sealing material or others. The solid state track detector 12 is a plate of, e.g., allyl diglycol carbonate (Trademark: CR-39). The size of the solid state track detector 12 is, e.g., 90 mm×90 mm×1 mm.

When the heavy charged particles of α rays, etc. pass through a solid, the atomic arrangement in the solid is deformed along the passages of the heavy charged particles, and tracks (radiation damages) are formed. In etching the solid with the tracks formed in with a chemical liquid, the etching advances at a relatively high rate along the tracks, and etch pits which can be observable with an optical microscope are formed. The solid state track detector is a radiation detector which can detect a dose of the radiation by using such principle.

Then, the sample 10 and the solid state track detector 12 superimposed on each other are loaded in a chamber 14 (see FIG. 1A). To ensure the incidence of a rays emitted from the sample 10, it is preferable to adhere the sample 10 and the solid state track detector 12 to each other. The chamber 14 is connected to a vacuum pump 18 through a pipe 16. The chamber 14 is, e.g., a stainless chamber. The surface of the solid state track detector 12, which contacts the sample 10 functions as the detection surface for detecting α rays emitted from the sample 10.

Then, the air inside the chamber 14 is evacuated with the vacuum pump 18 to place the inside of the chamber 14 in a vacuum state. The pressure inside the chamber 14 is, e.g., 1×10⁻¹ Pa or below.

Then, with the inside of the chamber 14 set in the vacuum state, the sample 10 and the solid state track detector 12 are left in the chamber 14 for a prescribed period of time. The period of time during which the sample 10 and the solid state track detector 12 are left in the chamber 14 is, e.g., hundreds hours to thousands hours, i.e., several weeks to several months.

It can happen that before the sample 10 and the solid state track detector 12 are superimposed on each other, tracks have been formed by α rays, etc. in the solid state track detector 12 at several parts. Such tracks will be formed by, e.g., radioactive substances, such as radon, etc., present in the air. Also by traces of radioactive substances contained in the solid state track detector 12 itself, such tracks will be formed. A number of such tracks formed in advance in the solid state track detector 12 are called a background.

To measure the dose rate of α rays with high precision, it is important to make the influence of the background ignorably small. To make the influence of the background ignorably small, the time in which the sample 10 and the solid state track detector 12 are superimposed on each other, i.e., the leaving period of time is set long. This is because in the present embodiment, as will be described later, a number of etch pits is divided by a leaving period of time to give a dose rate of α rays.

The inside of the chamber 14 is placed in the vacuum state in the present embodiment for the following reason.

That is, generally, radioactive substances, such as radon (²¹⁸Rn, ²¹⁹Rn, ²²⁰Rn), etc. are contained in the air. Accordingly, when the sample 10 and the solid state track detector 12 are left, simply superimposed on each other, the radioactive substances present in the air often intrude between the sample 10 and the solid state track detector 12. Then, the α ray tracks due to the radioactive substances present in the air are often formed, which makes it impossible to accurately measure the does of α rays emitted from the sample 10 alone. In the present embodiment, the sample 10 and the solid state track detector 12 are left in the chamber 14 having the inside air evacuated, whereby the dose of α rays emitted from the sample 10 alone can be accurately measured without being influenced by radioactive substances present in the air.

When the air is present between the sample 10 and the solid state track detector 12, α rays emitted from the sample 10 are often prevented from arriving at the surface of the solid state track detector 12. This makes it difficult to accurately measure the dose of α rays emitted from the sample 10. In the present embodiment, in the chamber 14 having the air evacuated from the inside, the sample 10 and the solid state track detector 12 are left in the chamber 14, whereby the dose of α rays emitted from the sample 10 can be accurately measured without the arrival of the α rays from the sample 10 at the solid state track detector 12 being prevented by the air.

It is considered that α rays are emitted also from the chamber 14. However, the α ray has the property of low transmission, and even if α rays are emitted from the chamber 14, the α rays can arrive at a tens μm-depth from the surfaces of the sample 10 and the solid state track detector 12. Accordingly, the α rays emitted from the chamber 14 never arrive at the detection surface of the solid state track detector 12, i.e., the part where the sample 10 and the solid state track detector 12 are adhered to each other. Thus, even if α rays are emitted from the chamber 14, it causes no special problem in measuring the dose of α rays emitted from the sample 10.

After the prescribed period of time has passed, the sample 10 and the solid state track detector 12 are unloaded out of the chamber 14.

Next, the solid state track detector 12 is immersed in an etchant. The etchant is, e.g., NaOH solution or KOH solution. The etching advances at a higher rate at parts of the solid state track detector 12, on which the α rays were incident than at the part of the solid state track detector 12, on which α rays were not incident because chemical changes have been made in the molecules forming the solid state track detector 12 at the parts (tracks) on which the α rays were incident. Accordingly, when the solid state track detector 12 is immersed in the etchant the tracks of the α rays are enlarged, and etch pits 20 corresponding to the tracks of the α rays are formed in the surface of the solid state track detector 12 (see FIG. 1B). The diameter of the etch pits 20, e.g., about 10 μm.

Next, the number of the etch pits 20 is observed with an optical microscope, etc.

Next, based on a number n of the etch pits 20, a leaving period of time t and an area S of the detection surface, a does rate of the α rays per a unit area is given. The dose rate of the α rays per the unit area is given by n/t/S. As described above, often tracks of α rays have been formed in the solid state track detector 12 before the sample 10 and the solid state track detector 12 are superimposed on each other. Such background will be several to tens. In the present embodiment, a number of the etch pits is divided by a leaving period of time to give a dose rate of the α rays, and the background is less influential as the leaving period of time is set longer. Thus, according to the present embodiment, the dose rate of the α rays can be measured with very high precision.

Thus, the dose rate of the α rays emitted from the sample 10 can be measured.

The α ray dose rate measuring method according to the present embodiment is mainly characterized firstly in that the dose rate of the α rays emitted from the sample 10 is measured with the solid state track detector 12.

As described above, when the dose rate of the α rays is measured with the gas-flow type proportional counter, the lower detection limit is about 0.001 cph/cm², which is relatively high.

In the present embodiment, however, the sample 10 and the solid state track detector 12 are left for the relatively long period of time, and the dose rate of the α rays is given by dividing a number of the etch pits by the leaving period of time, which can make the background less influential as the leaving period of time is set longer. Thus, according to the present embodiment, the dose rate of the α rays can be given with very high precision.

The α ray dose rate measuring method according to the present embodiment is mainly characterized secondly in that the sample 10 and the solid state track detector 12 are left, superimposed on each other, more preferably adhered to each other.

According to the present embodiment, the sample 10 and the solid state track detector 12 are left, superimposed each other, which permits the α rays emitted from the sample 10 to be incident on the solid state track detector 12 without failure. Thus, according to the present embodiment, the dose rate of the α rays emitted from the sample 10 can be measured with high precision.

Furthermore, the α ray dose rate measuring method according to the present embodiment is also mainly characterized thirdly in that the sample 10 and the solid state track detector 12 are left in the chamber 14 having the inside kept evacuated.

According to the present embodiment, the sample 10 and the solid state track detector 12 are left in the chamber 14 having the inside kept evacuated, whereby the formation of tracks of α rays due to in radioactive substances present in the air in the solid state track detector 12 can be prevented. Without the air between the sample 10 and the solid state track detector 12, the α rays emitted from the sample 10 are never hindered by the air from arriving at the solid state track detector 12. Thus, according to the present embodiment, the dose rate of the a rays emitted from the sample 10 can be accurately measured.

### A Second Embodiment

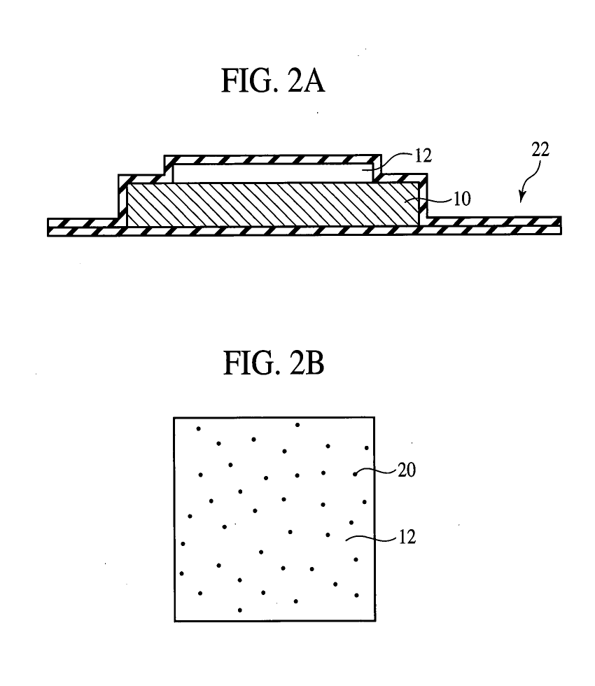

The α ray dose rate measuring method according to a second embodiment of the present invention will be explained with reference to FIGS. 2A and 2B. FIGS. 2A and 2B are views illustrating the steps of the α ray dose rate measuring method according to the present embodiment. The same members of the present embodiment as those of the α ray dose rate measuring method according to the first embodiment illustrated in FIGS. 1A and 1B are represented by the same reference numbers not to repeat or to simplify their explanation.

The α ray dose rate measuring method according to the present embodiment is characterized mainly in that a sample 10 and an solid state track detector 12 superimposed on each other are left, vacuum packed.

First, in the same way as in the α ray dose rate measuring method according to the first embodiment, the sample 10 and the solid state track detector 12 are prepared.

Next, the sample 10 and the solid state track detector 12 superimposed on each other is loaded in a vacuum pack container (vacuum pack bag) 22.

Next, the air in the vacuum pack container 22 is evacuated with a vacuum pump 18 (see FIG. 1A) to place the inside of the vacuum pack container 22 in a vacuum state. Thus, the sample 10 and the solid state track detector 12 are adhered to each other. Then, the vacuum pack container 22 is sealed (see FIG. 2A).

Then, the sample 10 and the solid state track detector 12 are left for a prescribed period of time. The period of time for which the sample 10 and the solid state track detector 12 are left is the same as in the first embodiment, i.e., hundreds hours to thousands hours.

It is considered that α rays are emitted also from the vacuum pack container 22. However, as described above, the α ray has the property of low transmission, and even if α rays are emitted from the vacuum pack container 22, the α rays can arrive at a tens μm-depth from the surfaces of the sample 10 and the solid state track detector 12. Accordingly, the α rays emitted from the vacuum pack container 22 never arrive at the detection surface of the solid state track detector 12, i.e., the part where the sample 10 and the solid state track detector 12 are adhered to each other. Thus, even if α rays are emitted from the vacuum pack container 22, it causes no special problem in measuring the dose of α rays emitted from the sample 10

Then, the sample 10 and the solid state track detector 12 are unloaded out of the vacuum pack container 22.

Next, in the same way as in the α ray dose rate measuring method according to the first embodiment, the solid state track detector 12 is immersed in an etchant. The etchant is, e.g., NaOH solution or KOH solution, as in the α ray dose rate measuring method according to the first embodiment. The tracks due to α rays incident on the solid state track detector 12 are enlarged by the etching, and etching pits 20 corresponding to the tracks of the α rays are formed in the solid state track detector 12 (see FIG. 2B).

Next, in the same way as in the α ray dose rate measuring method according to the first embodiment, a number of the etch pits 20 is observed with an optical microscope.

Next, in the same way as in the α ray dose rate measuring method according to the first embodiment, based on a number n of the etch pits 20, a leaving period of time t and an area S of the detecting surface, a dose rate of the α rays per a unit area is given.

Thus, the dose rate of the α rays emitted from the sample 10 is measured.

The sample 10 and the solid state track detector 12 superimposed on each other may be left, thus vacuum packed. According to the present embodiment, the dose rate of the α rays can be accurately measured with the simple constitution without operating the vacuum pump 18 for the long period of time.

### A Third Embodiment

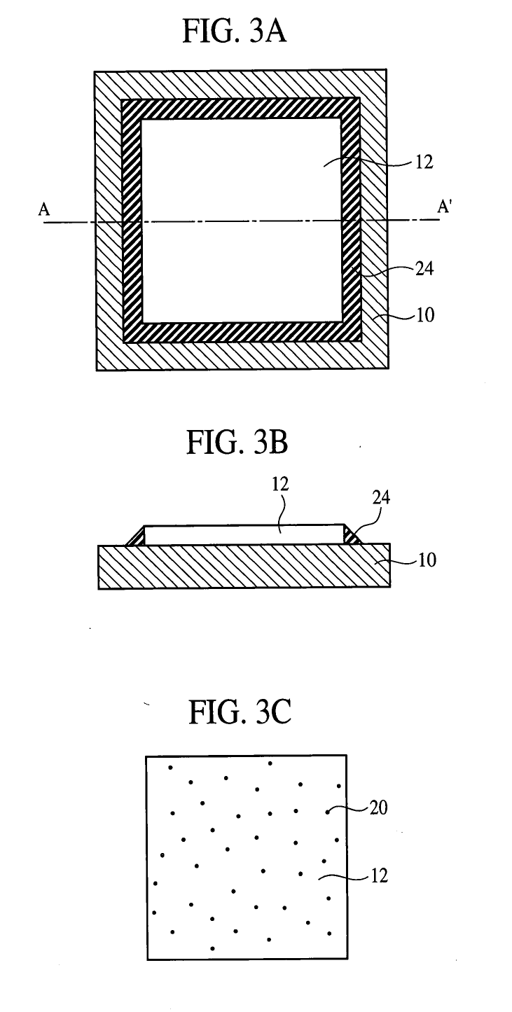

The α ray dose rate measuring method according to a third embodiment will be explained with reference to FIGS. 3A to 3C. FIGS. 3A to 3C are views illustrating the steps of the α ray dose rate measuring method according to the present embodiment. FIG. 3A is a plan view, and FIG. 3B is the sectional view along the line A-A′ in FIG. 3A. The same members of the present embodiment as those of the α ray dose rate measuring method according to the first or the second embodiment illustrated in FIGS. 1A to 2B are represented by the same reference numbers not to repeat or to simplify their explanation.

The α ray dose rate measuring method according to the present embodiment is characterized mainly in that a sample 10 and an solid state track detector 12 are left, superimposed on each other with the periphery of the superimposed parts sealed.

First, in the same way as in the α ray dose rate measuring method according to the first embodiment, the sample 10 and the solid state track detector 12 are prepared.

Next, the sample 10 and the solid state track detector 12 are superimposed on each other. Thus, the sample 10 and the solid state track detector 12 are adhered to each other.

Next, the periphery of the superimposed parts of the sample 10 and the solid state track detector 12 is sealed with a sealant 24 (see FIGS. 3A and 3B). The sealant 24 is formed of, e.g., resin. Then, the sample 10 and the solid state track detector 12 are left for a prescribed period of time. The prescribed period of time for which the sample 10 and the solid state track detector 12 are left is, e.g., hundreds hours to thousands hours, as in the above-described embodiments.

Due to radioactive substances present in the air, a rays will be incident on the exposed surfaces of the sample 10 and the solid state track detector 12. However, as described above, because the α ray has the property of the low transmission, α rays can arrive only at a tens μm-depth from the exposed surfaces of the sample 10 and the solid state track detector 12. Accordingly, α rays due to radioactive substances present in the air never arrive at the detection surface of the solid state track detector 12, i.e., the part where the sample 10 and the solid state track detector 12 are adhered to each other. Even if the sample 10 and the solid state track detector 12 are left in the air, no special problem takes place in measuring the dose of α rays emitted from the sample 10.

Next, the sealant 24 is released.

Then, in the same way as in the α ray dose rate measuring method according to the above-described embodiment, the solid state track detector 12 is immersed in an etchant. The etchant is, e.g., NaOH solution or KOH solution, as in the α ray dose rate measuring method according to the above-described embodiments. The tracks of α rays incident on the solid state track detector 12 are enlarged by the etching, and etch pits 20 corresponding to the tracks of the α rays are formed in the solid state track detector 12 (see FIG. 3C).

A number of the etch pits 20 is observed with an optical microscope, as in the α ray dose rate measuring method according to the above-described embodiments.

Next, in the same way as in the α ray dose rate measuring method according to the above-described embodiments, based on a number n of the etch pits, a leaving period of time t and an area S of the detection surface, a dose rate of the α rays per a unit area is given.

Thus, the dose rate of the α rays emitted from the sample 10 is measured.

As described above, the periphery of the part where the sample 10 and the solid state track detector 12 are adhered to each other may be sealed with the sealant 24. According to the present embodiment, the periphery of the part where the sample 10 and the solid state track detector 12 are superimposed on each other is sealed with the sealant 24, whereby after sealed with the sealant 24, the air containing radioactive substances never additionally intrude between the sample 10 and the solid state track detector 12. Thus, the present embodiment as well can measure with high precision α rays emitted from the sample 10. Furthermore, according to the present embodiment, the sample 10 dose not have to be loaded in the chamber 14 (see FIGS. 1A and 1B) or the vacuum pack container 22 (see FIGS. 2A and 2B), which allows the sample 10 to be measured even when the sample 10 is relatively large.

### A Fourth Embodiment

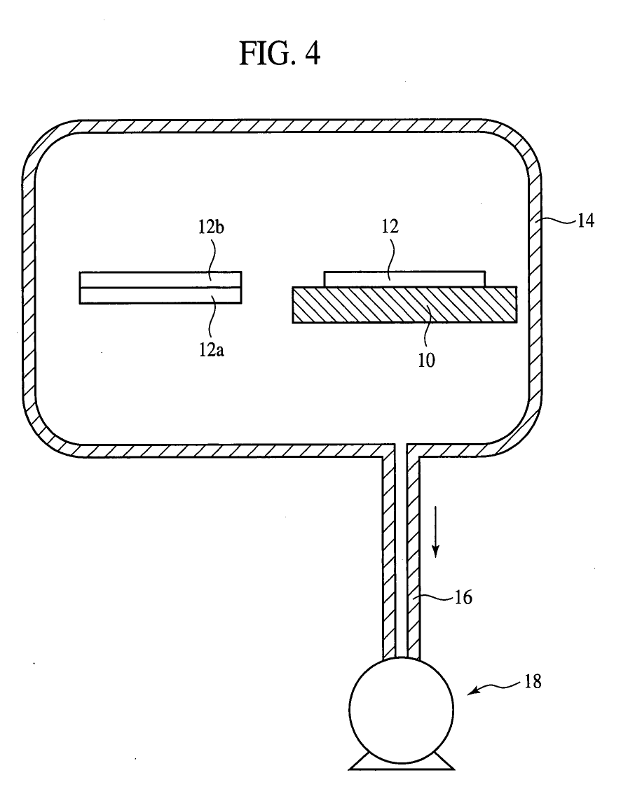

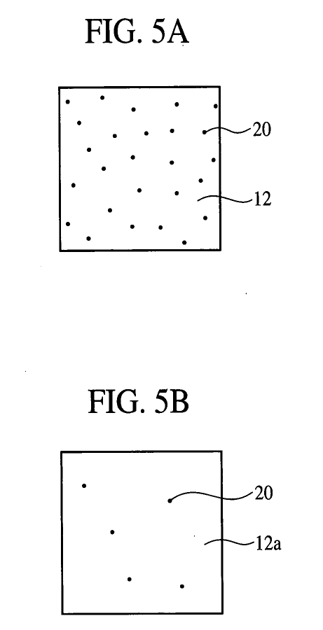

The α ray dose rate measuring method according to a fourth embodiment of the present invention will be explained with reference to FIGS. 4 to 5B. FIGS. 4 to 5B are views illustrating the steps of the α ray dose rate measuring method according to the present embodiment. The same members of the present embodiment as those of the a ray dose rate measuring method according to first to the third embodiments illustrated in FIGS. 1A to 3C are represented by the same reference numbers not to repeat or to simplify their explanation.

The α ray dose rate measuring method according to the present embodiment is characterized mainly in that a plurality of other solid state track detectors 12a, 12b which have been manufactured in the same lot as the solid state track detector 12 are left for a prescribed period of time, superimposed on each other, and an α ray dose rate given based on a number of the etch pits 20 formed in the other solid state track detector 12a is subtracted from a does rate of α rays given based on a number of etch pits 20 formed in the solid state track detector 12.

First, three solid state track detectors 12, 12a, 12b manufactured in the same lot, and a sample 10 are prepared.

Then, the sample 10 and the solid state track detector 12 superimposed on each other is loaded in a chamber 14. The rest two solid state track detectors 12a, 12b superimposed on each other are loaded in the chamber 14.

Next, in the same way as in the α ray dose rate measuring method according to the first embodiment, the air in the chamber 14 is evacuated with a vacuum pump 18 to place the inside of the chamber 14 in a vacuum state.

Then, in the same way as in the α ray dose rate measuring method according to the first embodiment, the sample 10 and the solid state track detectors 12, 12a, 12b are left for a prescribed period of time in the chamber 14 placed in the vacuum state. The period of time for which the sample 10 and the solid state track detectors 12, 12a, 12b are left is, e.g., hundreds hours to thousands hours, as described above. The pressure in the chamber 14 is, e.g., 10⁻¹ Pa or below.

Then, the sample 10 and the solid state track detectors 12, 12a, 12b are unloaded out of the chamber 14.

Then, the respective solid state track detectors 12, 12a, 12b are immersed in an etchant. The etchant is NaOH solution or KOH solution, as described above. Tracks of a rays incident on the solid state track detectors 12, 12a are enlarged by the etching, and etch pits 20 corresponding to the tracks of the α rays are formed in the solid state track detectors 12, 12a.

Next, a number of the etch pits 20 formed in each of the solid state track detectors 12, 12a is observed with an optical microscope.

Next, based on a number n of the etch pits formed in the solid state track detector 12, a leaving period of time t and an area S of the detection surface, a dose rate of a rays per a unit area is given. Based on a number n′ of the etch pits formed in another solid state track detector 12a, a leaving period of time t′ and an area S′ of the detection surface, a dose rate of α rays per a unit area is given. Then, a dose rate of α rays given based on a number n′ of the etch pits formed in said another solid state track detector 12a is subtracted from a dose rate of α rays given based on a number n of the etch pits formed in the solid state track detector 12.

In the present embodiment, for the following reason, a dose rate of α rays given based on a number of the etch pits 20 formed in the solid state track detector 12a is subtracted from a dose rate of α rays given based on a number of the etch pits 20 formed in the solid state track detector 12.

That is, as described above, tracks of α rays, etc. could be formed in the solid state track detector 12 before the sample 10 and the solid state track detector 12 are superimposed on each other. Tracks could be formed in the solid state track detector 12 due to α rays emitted from the solid state track detector 12 itself. The solid state track detectors 12a, 12b which have been manufactured in the same lot as the solid state track detector 12 are left, superimposed on each other under the same conditions as the solid state track detector 12, whereby a sum of a number of tracks preformed in the solid state track detector 12a and a number of tracks due to α rays emitted from the solid state track detector 12a is substantially equal to a sum of a number of tracks preformed in the solid state track detector 12 and a number of tracks due to α rays emitted from the solid state track detector 12 itself. Accordingly, a dose rate of α rays given based on a number of the etch pits 20 formed in another solid state track detector 12a is subtracted from a dose rate of α rays given based on a number of the etch pits 20 formed in the solid state track detector 12, whereby a part of the tracks preformed in the solid state track detector 12 and a part of the tracks due to α rays emitted from the solid state track detector 12 itself can be excluded, and the dose rate of α rays emitted from the sample 10 alone can be given with high precision.

(Evaluation Result 1)

Then, Evaluation Result 1 of the α ray dose rate measuring method according to the present embodiment will be explained.

As the sample 10, a silicon substrate with a Cu film form on was prepared. The period of time for which the sample 10 and the solid state track detectors 12, 12a, 12b are left in the chamber 14 was 2689.85 hours. The solid state track detector 12 left, superimposed on the sample 10 was etched, and forty-six etch pits 20 were observed. On the other hand, the solid state track detector 12a left, superimposed on the solid state track detector 12b was etched, and twelve etch pits 20 were observed. The areas of the detection surfaces of the solid state track detectors 12, 12a were both 171.8 cm².

The dose rate per the unit area given based on these results was (46−12)/171.8/2689.85=7.4×10⁻⁵ cph/cm².

Based on this, it is found that according to the present embodiment, the dose rate of α rays can be given in the order so low as 10⁻⁵ cph/cm². That is, according to the present embodiment, the dose rate of α rays can be given with very high precision.

(Evaluation Result 2)

Then, Evaluation Result 2 of the α ray dose rate measuring method according to the present embodiment will be explained.

As the sample 10, a plate of lead was prepared. The period of time for which the sample 10 and solid state track detector 12 were left in the chamber 14 was 620.41 hours. The solid state track detector 12 left, superimposed on the sample 10 was etched, and 7200 etch pits 20 were observed. On the other hand, the solid state track detector 12a left, superimposed on the solid state track detector 12b was etched, and six etch pits 20 were observed. The areas of the detection surfaces of the solid state track detectors 12, 12a were both 56.5 cm².

The dose rate per the unit area given based on these results was (7200−6)/56.5/640.41=0.21 cph/cm².

The α ray dose rate measuring method according to the present embodiment is characterized mainly in that, as described above, a plurality of other solid state track detectors 12a, 12b manufactured in the same lot as the solid state track detector 12 were left, superimposed on each other for a prescribed period of time, and a dose rate of α rays given based on a number of the etch pits 20 formed in another solid state track detector 12a is subtracted from a dose rate of α rays given based on a number of the etch pits 20 formed in the solid state track detector 12.

According to the present embodiment, a dose rate of a rays given based on a number n′ of the etch pits formed in another solid state track detector 12a is subtracted from a dose rate of α rays given based on a number n of the etch pits formed in the solid state track detector 12, whereby the dose rate of α rays emitted from the sample 10 alone can be measured with higher precision.

### A Fifth Embodiment

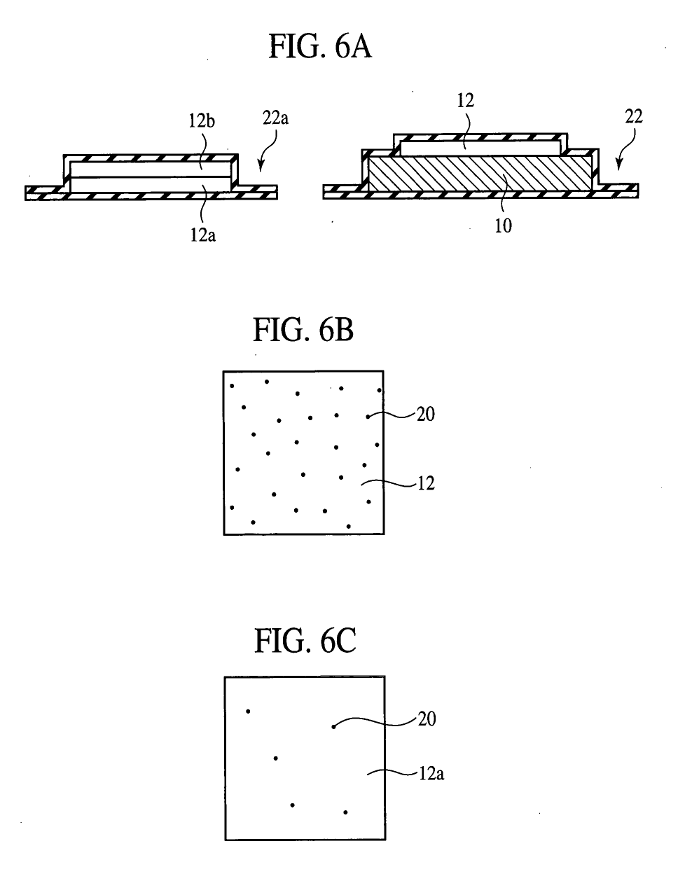

The α ray dose rate measuring method according to a fifth embodiment of the present invention will be explained with reference to FIGS. 6A to 6C. FIGS. 6A to 6C are views illustrating the steps of the α ray dose rate measuring method according to the present embodiment. The same members of the present embodiment as those of the α ray dose rate measuring method according to the first to the fourth embodiments illustrated in FIGS. 1A to 5B are represented by the same reference numbers not repeat or to simplify their explanation.

The α ray dose rate measuring method according to the present embodiment is characterized mainly in that solid state track detectors 12a, 12b manufactured in the same lot as an solid state track detector 12 superimposed on a sample 10 are left, superimposed on each other, vacuum packed.

First, three solid state track detectors 12, 12a, 12b manufactured in the same lot, and the sample 10 are prepared.

Next, the sample 10 and the solid state track detector 12 superimposed on each other are loaded in a vacuum pack container 22.

Next, the air in the vacuum pack container 22 is evacuated with a vacuum pump 18 (see FIGS. 1A and 1B) to place the inside of the vacuum pack container 22 in a vacuum state. Then, the vacuum pack container 22 is sealed.

Next, the rest two solid state track detectors 12a, 12b superimposed on each other are loaded in another vacuum pack container 22a.

Next, the air in the vacuum pack container 22a is evacuated with the vacuum pump 18 to place the inside of the vacuum pack container 22a in a vacuum state. Then, the vacuum pack container 22a is sealed.

Then, the sample 10 and the solid state track detector 12 vacuum packed, and the rest solid state track detector 12a, 12b vacuum packed are left for a prescribed period of time. The leaving period of time is, e.g., hundreds hour to thousands hours, as in the above-described embodiments.

Then, the sample 10 and the solid state track detector 12 are unloaded out of the vacuum pack container 22. The rest solid state track detectors 12a, 12b are unloaded out of the vacuum pack container 22a.

Next, the solid state track detectors 12a, 12b are immersed in an etchant. The etchant is, e.g., NaOH solution or KOH solution, as in the above. Thus, the tracks of the α rays incident on the solid state track detector 12, 12a are enlarged by the etching, and etch pitchs 20 corresponding to the tracks of the α rays are formed respectively in the solid state track detectors 12, 12a.

Next, a number of the etch pitches 20 formed in each of the solid state track detector 12, 12a is observed with an optical microscope.

Next, based on a number n of the etch pits formed in the solid state track detector 12, a leaving period of time t and an area S of the detection surface, a dose rate of a rays per a unit area is given. A number n′ of the etch pits formed in another solid state track detector 12a, a leaving period of time t′ and an area S′ of the detection area, a dose rate of α rays per a unit area is given. Then, a dose rate of α rays given based on a number n′ of the etch pits formed in another solid state track detector 12a is subtracted from a dose rate of α rays given based on a number n of the etch pits formed in the solid state track detector 12.

Thus, the dose rate of α rays emitted from the sample 10 is measured.

As described above, when the sample 10 and the solid state track detector 12 are left, vacuum packed, the solid state track detectors 12a, 12b manufactured in the same lot as the solid state track detector 12 may be also left, vacuum packed.

### A Sixth Embodiment

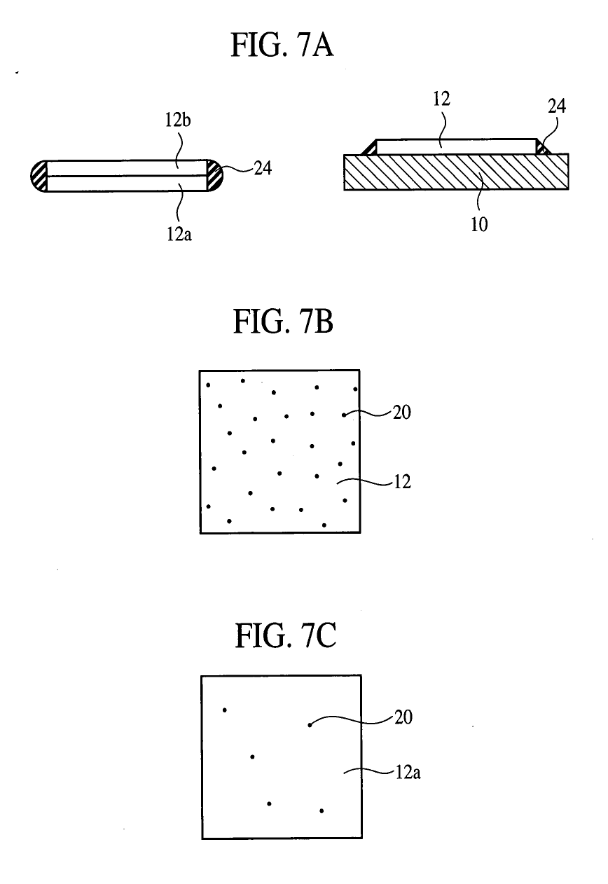

The α ray dose rate measuring method according to a sixth embodiment of the present invention will be explained with reference to FIGS. 7A to 7C. FIGS. 7A to 7C are sectional views illustrating the α ray dose rate measuring method according to the present embodiment. The same members of the present embodiment as those of the α ray dose rate measuring method according to the first to the fifth embodiments illustrated in FIGS. 1A to 6C are represented by the same reference numbers not to repeat or to simplify their explanation.

The α ray dose rate measuring method according to the present embodiment is characterized mainly in that a plurality of other solid state track detectors 12a, 12b manufactured in the same lot as the solid state track detector 12 superimposed on the sample 10 are superimposed on each other, the periphery of the solid state track detectors 12a, 12b is sealed with a sealant 24.

First, three solid state track detectors 12, 12a, 12b manufactured in the same lot, and the sample 10 are prepared.

Next, the sample 10 and the solid state track detector 12 are superimposed on each other.

Next, the periphery of the part where the sample 10 and the solid state track detector 12 are superimposed on each other is sealed with the sealant 24. The sealant 24 is formed of, e.g., resin, as in the above.

Next, the solid state track detector 12a and the solid state track detector 12b are superimposed on each other.

Next, the periphery of the part where the solid state track detector 12a and the solid state track detector 12b are superimposed on each other is sealed with the sealant 24.

Then, the sample 10 and the solid state track detectors 12, 12a, 12b are left in a prescribed period of time. The leaving period of time for the sample 10 and the solid state track detectors 12, 12a, 12b is, e.g., hundreds hours to thousands hours, as in the above.

Next, the sealant 24 is released.

Next, the solid state track detectors 12, 12a are immersed in an etchant. The etchant is, e.g., NaOH solution or KOH solution, as in the above. Thus, the tracks of α rays incident on the solid state track detectors 12, 12a are enlarged by the etching, and the etch pits 20 corresponding to the tracks of the α rays are formed respectively in the solid state track detectors 12, 12a.

Next, a number of the etch pits 20 formed in each of the solid state track detectors 12, 12a is observed with a optical microscope.

Then, based on a number n of the etch pits formed in the solid state track detector 12, a leaving period of time t and an area S of the detection surface, a dose rate of a rays per a unit area is given. Based on a number n′ of the etch pits formed in the solid state track detector 12a, a leaving period of time t′ and an area S′ of the detection surface, a dose rate of α rays per a unit area is given. Then, a dose rate of α rays given based on a number n′ of the etch pits 20 formed in the solid state track detector 12a is subtracted from a dose rate given based on a number n of the etch pits 20 formed in the solid state track detector 12.

Thus, a dose rate of α rays emitted from the sample 10 is measured.

As described above, when the part where the sample 10 and the solid state track detector 12 are superimposed on each other is sealed with the sealant 24, the solid state track detectors 12a, 12b manufactured in the same lot as the solid state track detector 12 may be left, superimposed on each other with the part where the solid state track detectors 12a, 12b are superimposed on each other sealed with the sealant 24.

### Modified Embodiments

The present invention is not limited to the above-described embodiments and can cover other various modifications.

For example, in the above-described embodiments, the solid state track detectors are formed of allyl diglycol carbonate but may not be formed essentially of allyl diglycol carbonate. The solid state track detector can be formed suitably of any other resin which can have etch pits corresponding to tracks of α rays.

### INDUSTRIAL APPLICABILITY

The α ray dose rate measuring method according to the present invention is useful to measure with high precision the dose rate of α rays emitted from a sample.

1. An α ray dose rate measuring method comprising:
the first step of leaving a solid state track detector and a sample superimposed on each other for a prescribed period of time;
the second step of etching the solid state track detector to thereby forming in the solid state track detector etch pits corresponding to tracks of α rays incident on the solid state track detector; and
the third step of giving a dose rate of α rays emitted from the sample, based on a number of the etch pits formed in the solid state track detector and the leaving period of time.

2. An α ray dose rate measuring method according to claim 1, wherein
in the first step, the solid state track detector and the sample are left in an evacuated chamber.

3. An α ray dose rate measuring method according to claim 1, wherein
in the first step, the solid state track detector and the sample are left in evacuated vacuum pack container.

4. An α ray dose rate measuring method according to claim 1, wherein
in the first step, the solid state track detector and the sample are left with the periphery of a part where the solid state track detector and the sample are superimposed on each other sealed.

5. An α ray dose rate measuring method according to claim 1, wherein
the solid state track detector is formed of resin.

6. An α ray dose rate measuring method according to claim 5, wherein
the resin is allyl diglycol carbonate.

7. An α ray dose rate measuring method according to claim 6, wherein
in the second step, the etching is made with NaOH solution or KOH solution.

8. An α ray dose rate measuring method according to claim 1, wherein
in the third step, the number of etch pits are observed with an optical microscope.

9. An α ray dose rate measuring method according to claim 1, wherein
in the first step, the other two solid state track detectors manufactured in the same lot as said solid state track detector are left for a prescribed period of time, superimposed on each other,
in the second step, one of said other two solid track state detectors is etched to thereby form in said one of other two solid state track detectors etch pits corresponding to tracks of α rays incident on said one of other two solid state track detectors, and
in the third step, a dose rate of α rays given based on the number of the etch pits formed in said one of other two solid state track detectors is subtracted from a dose rate of α rays given based on the number of the etch pits formed in said solid state track detector to thereby give a dose rate of α rays emitted from the sample.
